(19) United States
(12) Patent Application Publication
(10) Pub. No.: US 2018/0232680 A1
(43) Pub. Date: Aug. 16, 2018

(54) System, Method, and Apparatus for Assessing and Managing Workforce Performance

(71) Applicants: Denise Hazime, Irvine, CA (US); Harprit Bhui, Irvine, CA (US)

(72) Inventors: Denise Hazime, Irvine, CA (US); Harprit Bhui, Irvine, CA (US)

(21) Appl. No.: 15/433,802

(22) Filed: Feb. 15, 2017

(51) Int. Cl. G06Q 10/06; G06Q 10/10

(52) U.S. Cl. CPC G06Q 10/06398; G06Q 10/10

(57) ABSTRACT

The disclosure is directed towards the assessments used to facilitate management of members in a given workforce. More particularly, elements comprising a system, method, and apparatus are operative to quantify individual worker engagement with resources made available in a digitally implemented office network. Such elements may be further operative to compare each individual worker's engagement with such resources against his own historical engagement, each other worker's historical and present engagement, as well as any predetermined engagement thresholds in order to gauge worker performance while avoiding traditional limitations imposed by remote-work arrangements.

### GOVERNMENT CONTRACT

Not applicable.

### CROSS-REFERENCE TO RELATED APPLICATIONS

Not applicable.

### STATEMENT RE. FEDERALLY SPONSORED RESEARCH/DEVELOPMENT

Not applicable.

### COPYRIGHT & TRADEMARK NOTICES

A portion of the disclosure of this patent document may contain material which is subject to copyright protection. This patent document may show and/or describe matter which is or may become trade dress of the owner. The copyright and trade dress owner has no objection to the facsimile reproduction by any one of the patent document or the patent disclosure, as it appears in the Patent and Trademark Office patent files or records, but otherwise reserves all copyrights and trade dress rights whatsoever.

### TECHNICAL FIELD

The disclosed subject matter relates generally to systems for managing workforces and, more particularly, to systems for quantifying productivity and assessing performance of individual workers among a plurality of workers in an office environment.

### BACKGROUND

The following is a tabulation of some prior art that presently appears relevant to this disclosure:

### U.S. Patents

| Pat. No. | Kind Code | Issue Date | Patentee |
|---|---|---|---|
| 5,696,702 | | Dec. 9, 1997 | Skinner et al. |
| 5,963,914 | | Oct. 5, 1999 | Skinner et al. |
| 7,467,198 | B2 | Dec. 16, 2008 | Goodman et al. |
| 7,500,140 | B2 | Mar. 3, 2009 | Day et al. |
| 9,047,464 | B2 | Jun. 2, 2015 | Sambamurthy et al. |

### U.S. Patent Application Publications

| Publication Number | Kind Code | Pub. Date | Applicant |
|---|---|---|---|
| 2006/0284838 | A1 | Dec. 21, 2006 | Tsatalos et al. |
| 2009/0222552 | A1 | Sep. 3, 2009 | Chroscielewski et al. |
| 2013/0074075 | A1 | Mar. 21, 2013 | Cavalcante et al. |
| 2016/01647575 | A1 | Dec. 9, 1997 | Skinner et al. |

### Foreign Patent Document

None found

### Foreign Patent Document

None found

### DISCUSSION OF THE RELATED ART

Recent improvements in web-based computing have alleviated some traditional restraints on work-place performance. Indeed, the advent of cloud-based software in particular has, to some extent, freed workers from necessarily completing tasks in a designated, physical office environment and allowed them to work from any location with an internet connection. Still, workers and managers alike have faced several problems when faced with this freedom. Most notably, many managers are uncomfortable with remote work arrangements because it can be difficult to ensure that remote workers are focused on their assigned tasks when not engaged in an environment having means for affecting physical oversight.

Various proposals for monitoring and/or managing worker performance have been proposed. Some proposals rely, for example, on measuring sales quotas. Although it is possible to obtain data related to sales quotas even from remote workers, such as by examination of authenticated receipt submissions or other sales logs, this proposal is deficient because sales quotas are only measurable after each sale has been attained. That is, any work done to achieve a sale or between sales is overlooked. This is particularly limited in applicability to business areas where sales occur frequently and/or over short time periods. Thus, monitoring whether a worker has met his or her quota fails to accurately portray his productivity. It is a measure of record rather than productivity or effectiveness. Indeed, quotas also fail to take productive efforts of operations and other sales support staff into consideration.

Similarly, some proposals rely on simple keystroke and time-logging data to paint a picture of a worker's job-related, on-task engagement with his or her computer. Unfortunately, these are also deficient because application across large numbers of remote workers is difficult to attain. For instance, some of these types of proposals must be installed on each of a user's personal computing devices used on the job. This can be expensive to implement, and in some instances, may fail to accurately summarize abstract markers of productivity and performance, such as, for example, overall resource utilization.

Thus, there remains a need for a system, method, and apparatus configured to enable monitoring and management of performance and/or productivity of numerous workers operating independently within a digitally implemented office network or even virtual office environment.

### SUMMARY

The present disclosure is directed to management of members operating in an electronically networked workforce. For purposes of summarizing, certain aspects, advantages, and novel features have been described. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested.

In an embodiment, elements comprising a system, method, and apparatus for assessing and managing workforce performance may be operative to receive data correlating to each individual worker's engagement with resources available in a digitally implemented office network.

In one embodiment, the office network may be remote or otherwise virtual and may include, for example, a variety of bundled productivity software, or “resources”, such as any of those operative to enabling phone, email, and instantaneous intra and inter network communication, calendaring, word processing, even screen and/or document-sharing capabilities known in the art. Some examples of digitally implemented office networks and even virtual office environments including at least some of the foregoing resources, among others, are available to consumers, such as business owners, under the tradenames G Suite™ offered by Google®, Amazon WorkSpaces™, Office 365® offered by Microsoft®, and Polaris Office®. Of course, many office networks and/or virtual office environments may be available, the foregoing list is offered by way of example only and not of limitation.

More particularly, the elements of the system, method, and apparatus described in further detail below, are operative to quantify individual worker engagement with any of the resources made available in such an office environment. Such elements may be further operative to compare each individual worker's engagement against his own historical engagement, each other worker's historical engagement, each other worker's present engagement, as well as any predetermined engagement thresholds, in order to gauge worker performance while avoiding traditional limitations on work-force management typically imposed by remote-work arrangements. As such, it is contemplated that the disclosed system, method, and apparatus for assessing and managing workforce performance may be operative to demonstrate how each individual within a larger workforce is performing over any desirable period of time. In turn, managers and others such as owners, executives and administrators in charge of workers performing in the workforce may determine where time is being lost, whether resources are being under and/or over-utilized by some individuals and even compare utilization to others′. Such determinations may then influence decisions relating to individual promotions, assignments, resource allocation, etc.

In one embodiment, determinations may be summarized or otherwise presented as a productivity or performance score. Indeed, individual, team, or group scores may be established based on what individual worker network members and/or manager members, and even preselected groups of such members, accomplish using resources in the office environment. By way of example and not limitation, accomplishments might include time spent drafting and sending emails and executing phone calls, time spent generating reports and/or the number of reports generated, frequency and time spent collaborating and/or communicating with other members of the virtual environment, sales generated, and of course others. Of course, one skilled in the art will recognize that there may be innumerable ways of numerically comparing use of resources in the office environment. Thus, the exact method used to draw a score from engagement with resources in the office network should not limit the scope of the invention.

However calculated, it is contemplated that scores may be ultimately presented as metrics that enable managing members of the office network to quantify productivity and performance of their workers no matter how remotely they may be located, or in what type of office environment, in order to educate their management of such workers. For example, certain individuals' scores may be compared to other members' scores to identify opportunities for sales or other productivity improvement. In one exemplary embodiment, for instance, it may be discovered that a particular worker or group of workers has been underutilizing certain resources available in the office network over a certain period of time. Though such workers may be remote from their managers and even each other, the system will demonstrate a need for managing performance in such area and enable managers to act on such underutilization.

As another example, certain scores may demonstrate that some remote workers' engagement with resources in the office network has been particularly positive or otherwise beneficial over a certain period of time. For instance, some workers' scores may indicate that the workers have beneficially collaborated with others to draft important reports using word processing and intranetwork communications resources available in the office network which may have, in turn, yielded profitable results. Positive scores reflecting such engagement may be used to inform decisions regarding such workers' opportunities for promotion, bonuses, raises, and more.

Of course, the foregoing are offered by way of clarifying example only and not limitation. Scores may be used for a variety of purposes as desired by a company or managing members of such company.

It should be noted that in some embodiments, a private office network may define a virtual office environment enabled and/or accessed via the “cloud.” Those skilled in the art will recognize “cloud” computing as a type of internet-based computing that provides shared computer processing resources and data to computers and other devices on demand. Through the cloud, certain work-related activities, and others, may be performed via specialized applications such as office suites.

In particular, it is contemplated that hosting an office network as a virtual office environment in the cloud, and providing access to related computing tools and resources therein, may not only allow workers and managers to perform duties from any remote location providing access to Wi-Fi or cellular communication, but also may reduce the risk of workers and managers sharing sensitive documents outside of any firewall established in the cloud (e.g. through email, USB transfers, FTP, through third-party services, web/cloud file sharing, and the like). Additional security may be provided through, for example, IRM, encryption, and others known to those skilled in the art.

Collaboration between workers and managing members of the private office network may also include sync and share functionality, workflow tools, business intelligence, and the like, and provide greater secure connectivity and productivity, improving the workflow in association with clients, customers, vendors, suppliers, partners, professional service organizations, and leads, among others. Thus, methods and systems disclosed herein may include client and server-side, as well as cloud-deployed components, for managing access to resources, including based on policies associated with such resources, as well as such components for tracking, reporting, and managing access to resources, such as to keep consistent, synchronized versions of such resources across multiple access devices.

In light of the foregoing, it is contemplated that managers and employers will be enabled to make more informed decisions on how to best coach employees, contractors, and other workers in order to improve their overall performance in spite of any limitations imposed by remote-work arrangements.

As such, it is one object of the invention to quantify contributions made by individuals comprising a numerous, remote workforce to a business endeavor.

It is another object of the invention to drive worker performance on behalf of the business by quantifiably assessing each workers' engagement with resources available to each worker.

It is still another object of the invention to avoid inaccuracies that naturally plague self-reporting management systems typically used to determine productivity and performance by workers in a remote workforce.

It is still another object of the invention to monitor large numbers of remotely operating workers.

One or more of the above-disclosed embodiments, in addition to certain alternatives, are provided in further detail below with reference to the attached figures. The disclosed subject matter is not, however, limited to any particular embodiment disclosed.

### BRIEF DESCRIPTION OF THE DRAWINGS

FIG. 1 is a block diagram of a networked environment in which an exemplary embodiment of a system for assessing and managing workforce performance is implemented;

FIG. 2 is a flowchart depicting an exemplary embodiment of a method for assessing and managing workforce performance;

FIG. 3 is an exemplary embodiment of execution architecture in accordance with one embodiment of a system for assessing and managing workforce performance;

FIG. 4 illustrates an exemplary embodiment of a mobile device shown in FIG. 1;

FIG. 5 illustrates an alternative networked environment in which another exemplary embodiment of a system for assessing and managing workforce performance is implemented;

FIG. 6 illustrate an exemplary user interface for the system for assessing and managing workforce performance; and

FIG. 7 illustrate an exemplary user interface for the system for assessing and managing workforce performance.

One embodiment of the invention is implemented as a program product for use with a computer system. The program(s) of the program product defines functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive) on which information is permanently stored; (ii) writable storage media (e.g., floppy disks within a diskette drive or hard-disk drive) on which alterable information is stored. Such computer-readable storage media, when carrying computer-readable instructions that direct the functions of the present invention, are embodiments of the present invention. Other media include communications media through which information is conveyed to a computer, such as through a computer or telephone network, including wireless communications networks. The latter embodiment specifically includes transmitting information to/from the Internet and other networks. Such communications media, when carrying computer-readable instructions that direct the functions of the present invention, are embodiments of the present invention. Broadly, computer-readable storage media and communications media may be referred to herein as computer-readable media.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus

The terms “couple,” “coupled,” “couples,” “coupling,” and the like should be broadly understood and refer to connecting two or more elements or signals, electrically, mechanically or otherwise. Two or more electrical elements may be electrically coupled, but not mechanically or otherwise coupled; two or more mechanical elements may be mechanically coupled, but not electrically or otherwise coupled; two or more electrical elements may be mechanically coupled, but not electrically or otherwise coupled. Coupling (whether mechanical, electrical, or otherwise) may be for any length of time, e.g., permanent or semi-permanent or only for an instant.

### DETAILED DESCRIPTION

Having summarized various aspects of the present disclosure, reference will now be made in detail to that which is illustrated in the drawings. While the disclosure will be described in connection with these drawings, there is no intent to limit it to the embodiment or embodiments disclosed herein. Rather, the intent is to cover all alternatives, modifications and equivalents included within the spirit and scope of the disclosure as defined by the appended claims.

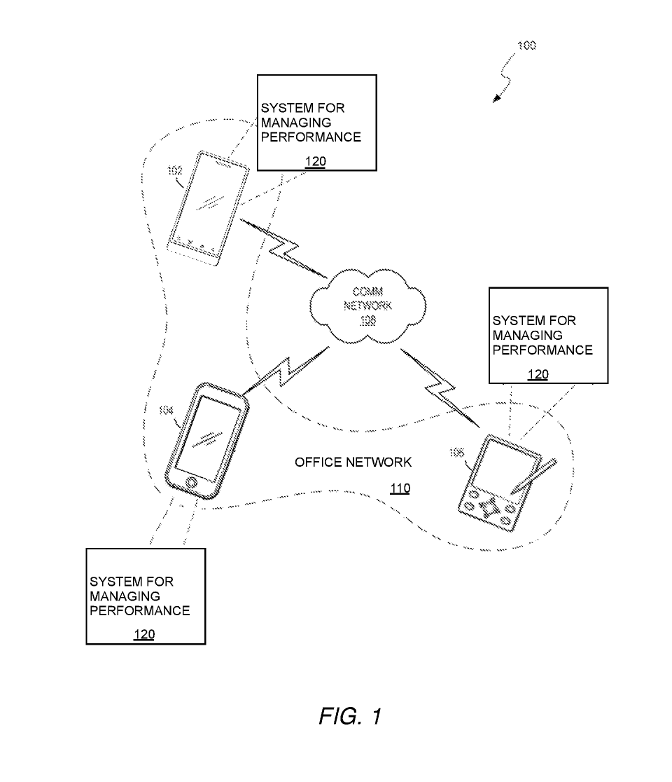

A description of an embodiment of a method and system for coordinating visits of members in a networked environment is now described followed by a discussion of the operation of various components within the system. In this regard, FIG. 1 is a block diagram of a networked environment in which an exemplary embodiment of a system for coordinating visits is implemented.

FIG. 1 illustrates an exemplary embodiment of the system for assessing and managing performance 100 which includes a plurality of electronic computing devices communicatively coupled to one another. By way of example, and not limitation, FIG. 1 illustrates three electronic devices 102, 104 and 106 communicatively coupled via a communication network 108. Each of the electronic devices may be embodied as a mobile computing device such as, for example and without limitation, a smartphone, laptop, or tablet computer, however it is also contemplated that the electronic devices may include desktop computers.

In one embodiment, users of electronic devices 102, 104 and 106 may access a private, digitally implemented office network 110 centered around a particular business or other organized commercial endeavor known to those skilled in the art. Of course, one skilled in the art will also recognize that the office network 110 may be centered around a variety of not-for-profit endeavors as well, include for example, volunteer organizations, thus any discussion of the network center as a business is for the sake of brevity and illustration only and not of limitation. The invention may be used to manage performance in an innumerable variety of remote workforces.

In this particular embodiment, the private office network may define a virtual office environment enabled and/or accessed via the “cloud.” Through the cloud, certain work-related activities, and others, may be performed via specialized applications such as office suites known to those skilled in the art. Notably, the communications network 108 can use one or more of various communications types such as, for example and without limitation, cellular and Wi-Fi communications. Such a network may be web-based in order to facilitate remote access by its members. As such, it is contemplated that the office network 110 enables members to use their devices 102, 104 and 106, to remotely execute tasks on behalf of the central business or other organization with each other in an office network. Indeed, in some embodiments, the network may define a virtual desktop, known to those skilled in the art, defined by sync and share functionality, workflow tools, business intelligence, and the like, and provide greater secure connectivity and productivity, improving the workflow in association with clients, customers, vendors, suppliers, partners, professional service organizations, and leads, among others. However, regardless of how such a network is implemented, the functionality of concern involves the ability to enable interaction among a limited group of members—including workers and managers—and further remotely log and manage performance of such members.

The network members may be selected from, for example and not limitation, employees, contractors, managers, owners, officers, administrators and others involved in the productivity and operation of the business. In the interest of clarity, the network members may be classified into at least two groups: workers and managers, for example. In some embodiments, the worker class may comprise employees and contractors hired to conduct day-to-day operations on behalf of the business' endeavors. This might include, for example and not limitation, sales people, analysts, and even entry level associates. In some embodiments, the manager class may comprise network members performing duties typically associated with middle and/or top level management on behalf of the business' endeavors. For instance, network members classed as managers may comprise general, senior, and/or assistant managers, managing directors, executives, executive officers, and others. In some embodiments, the roles of some manager network members and some worker network members may overlap, thus in some embodiments, an individual network member's classification as manager or worker may vary within the office network 110 and consequently system 100 without departing from the invention.

Classifying network members in the manner described may ensure that information available through the system 100 may be appropriately directed, visible, or otherwise accessible to relevant network members. As such, it is contemplated that at least one of the devices 102, 104 and 106, will correspond to a managing member of the office network 110, while a plurality of other devices, such as 102, 104 and 106 or others, will correspond to a plurality of remotely situated worker members of the office network 110.

In some embodiments, access to the network may be even further facilitated by a website that may require a registration and login prior to use. In one embodiment, one way to add a member to a network may be by a first member, who a managing member of the office network 110 using their device, for example electronic computing device 102, to send an invitation to another network member's device, for example electronic computing device 104, ultimately inviting them to join the office network 110. Each of the other users may be additional managers, administrators, other employees and even business contractors. In some embodiments access to the network may be restricted by managing member(s) to avoid compromising any proprietary or otherwise private data monitored and aggregated as a result of operative features of the system, method, and apparatus.

In some embodiments, sending a network invitation to another member will prompt such member to enter identification information or other credentials such as, by way of example, name and email address and even in some cases employee or contractor identification number. Upon engagement as an employee, manager, owner, or contractor for the business, and further authenticating relevant credentials that may define network membership requirements, the new member will be given access, using their electronic device 104, to all of the privileges enjoyed by the first member on their device 102.

In operation, the system 100 provides a better and more coordinated way in which a manager or group of managing individuals in a business can monitor the performance of a plurality of workers who conduct their duties on behalf of the business remotely from one another and their managers. Specifically, the system 100 correlates information that identifies members of the office network 110 with data characterizing each member's engagement with tools and applications available to them in, for example, a virtual office environment defined by or accessible via the private office network. For instance, temporal information may indicate the time spent on drafting, sending, and responding to emails via related computer applications hosted in the office network. As another example, temporal information may indicate the time spent telephonically communicating to potential clients, customers, or leads via related computer applications hosted in the office office network. As still another example, use information may indicate when and to what extent intra-office communications tools, such as chatting and screen-sharing information are used by each worker to collaborate with other members of the network. Of course, other engagement metrics may be used, the foregoing are offered by way of example only and not of limitation. Still, it is contemplated that the electronic computing devices may be operative to track and correlate a plurality of individual workers' engagement with any of a wide variety of applications and other software as may be used over the course of their remote work on behalf of their employer or manager(s).

As a result of such correlating, managing members of the network, and even the worker members themselves, if desired, may quantify each individual workers' productivity and performance in the digitally implemented office network, despite each managing and employee or contractor members' possibly remote location from each other. Indeed, the members may be provided with detailed information about engagement in the office network including, but not limited to, amount of time spent on business-related calls and emails, where such business-related calls and emails were executed, along with media that was created during such business-related calls and emails, among others, including, for example, data compilations and reports.

In this regard, mobile device 102 includes a system for managing performance 100 in a remote workforce, which can be implemented in numerous ways such as, for example and without limitation, an application executed on the electronic computing device. In operation, the system 100 receives member information to uniquely identify members of the network 110 (in this case, users of electronic devices 102, 104 and 106). Responsive to determining that a particular member has engaged with applications and other elements accessible via the private office network, the system 100 may automatically transmit information to managing members of the office network 110. In some embodiments, this information will be followed by a canned prompt appearing on the mobile devices 102, 104, and 106 such as a push notification or text message indicating that such information has been or is continuing to be transmitted.

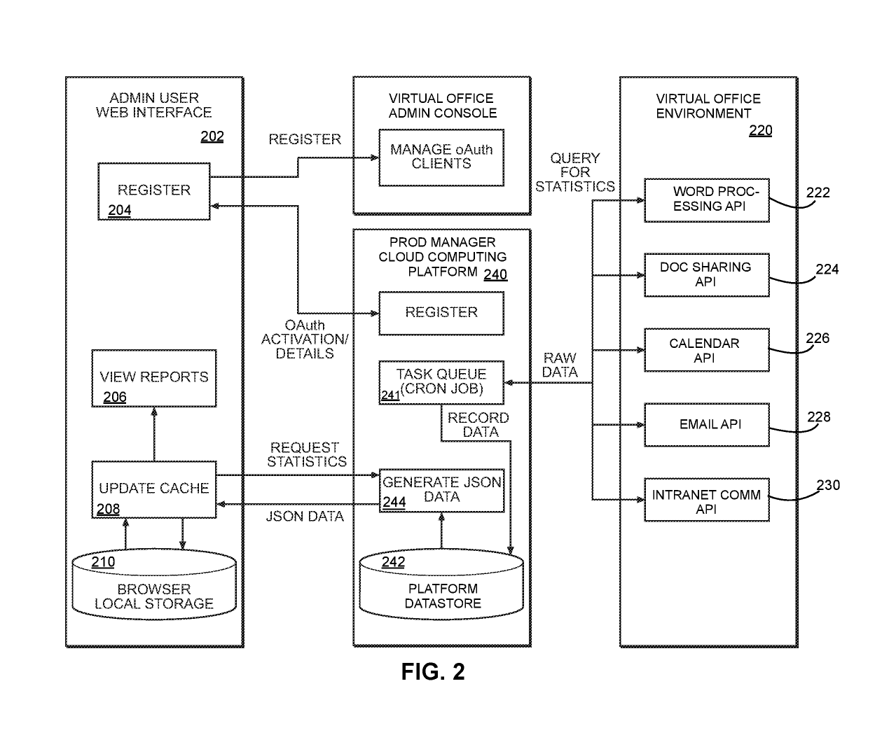

A diagram representing one non-limiting embodiment of the functionality of the system described above as an exemplary software architecture block diagram operatively implemented by one or more electronic computing devices may be seen in FIG. 2. Notably, access to the system may be limited to registered individuals whose membership may further be divided into classes, comprising for example, administrators, and workers. In some embodiments, an administrative user, such as a manager, may have access to a web-based interface 202 operative to register 204 other users, such as workers, and view reports 206 generated regarding each workers' engagement with resources available in the private office network. In one embodiment, the private office network may define a virtual office environment 220 hosted, for example, in a cloud computing platform 240.

Each registered member may have access to various electronic resources in the exemplary virtual office environment 220 which may be readable by all other registered members regardless of any particular configurations defining their own individual electronic computing devices. For example, a word processing application program interface (“API”) 222, document sharing API 224, calendaring API 226, emailing API 228, and intranet communication API 230, and other APIs as may be desirable to carry out tasks on behalf of a business or other endeavor. Data gathered from each resource available therein may then be directed from a task queue 241 in the cloud computing platform 240 to a datastore 242 in the cloud based computing platform 240, where it may be converted into readable data 244 such as JSON, RESTful, SOAP and others known in the art. Such data may be presented as viewable reports 206 in the web-based interface 202. Of course, local cache 208 and storage 210 are contemplated as well.

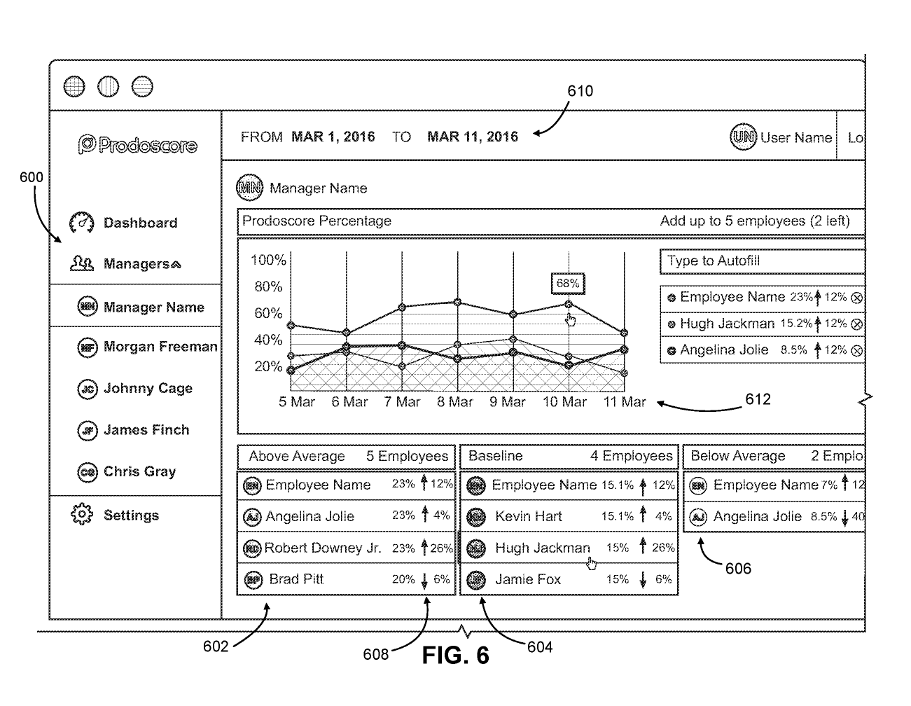

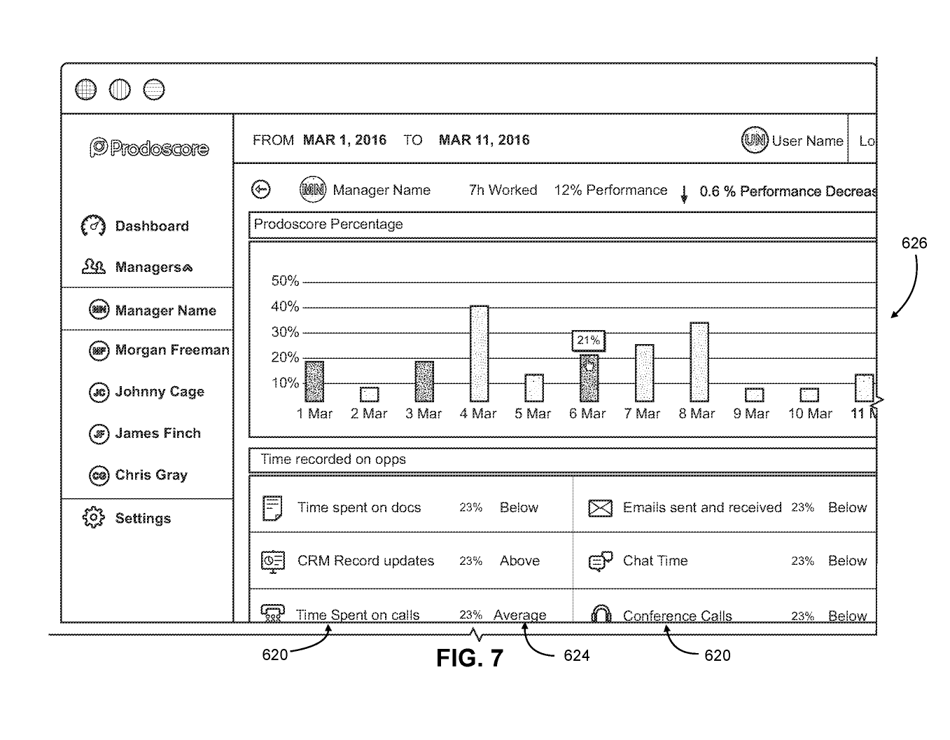

In other words, raw data drawn from each authorized members'—that is, the workers or other network members subject to management—absolute or temporal use of and/or engagement with various applications and other resources in the exemplary virtual office environment 220 may be transmitted to and maintained in a cloud computing platform 200. Such data may be transmitted in human-readable format to a user interface accessible to and viewable by managing members of the network, or administrators. Indeed, reports such as those illustrated for example in FIGS. 6 and 7, described below, may be generated to provide a visual representation of performance, for example in the form of scores, for all of or a portion of the working members in the network. Such visual representation may allow managing members to assess individual worker performance against his or her historical performance, predetermined threshold performance, and even against performance of other worker members.

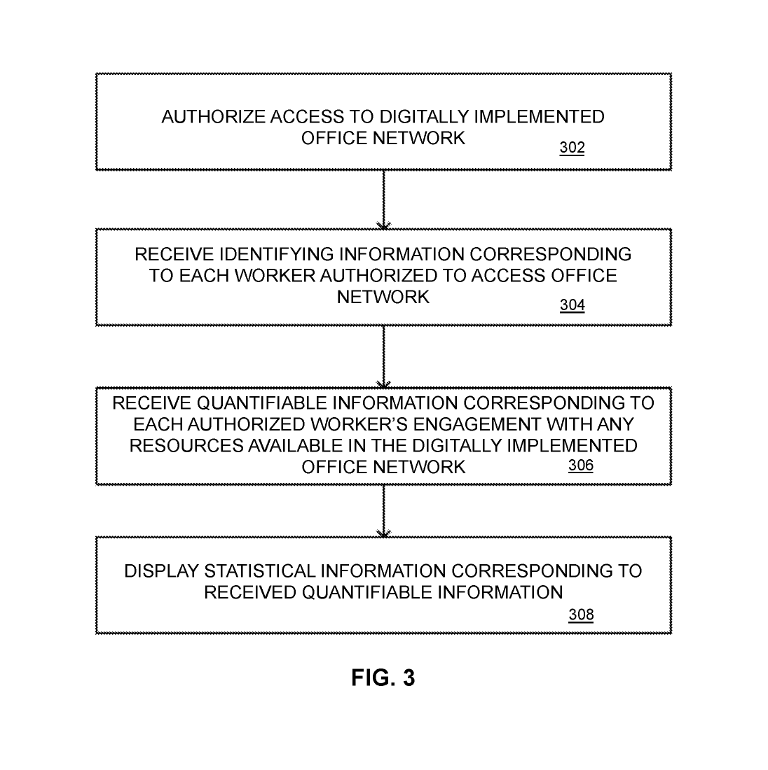

FIG. 3 is a flowchart depicting an exemplary embodiment of a system and method for managing performance in a remote workforce such as may be performed by an electronic computing device such as 102 104, and 106 of FIG. 1. As shown in FIG. 3, the method may comprise at least the steps of: authorizing access to a digitally implemented office network (block 302); receiving information identifying each of a plurality of workers authorized to access the office network (block 304); receiving information regarding each authorized worker's engagement with resources available in the office network (block 306); and displaying statistical information corresponding to the received information (block 308).

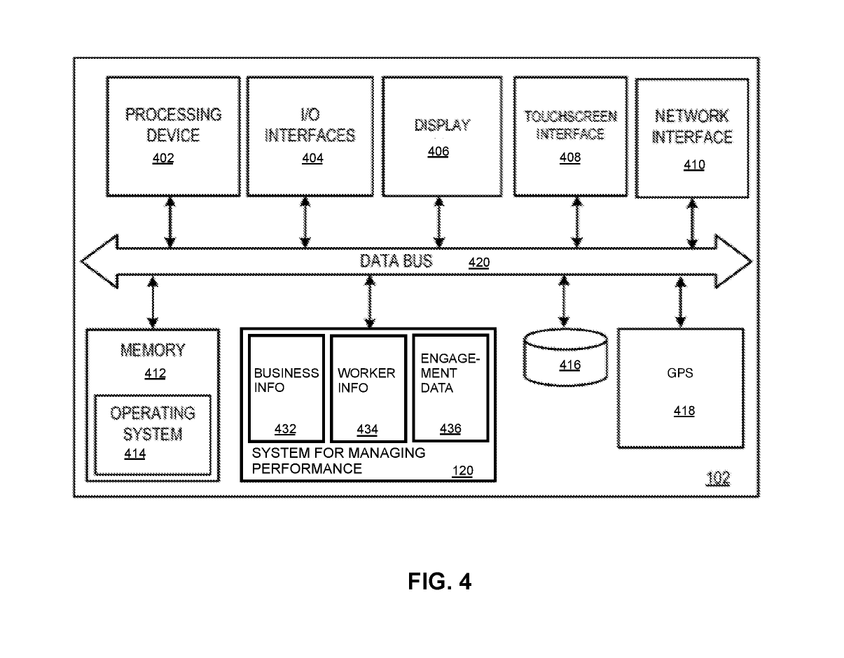

FIG. 4 illustrates one embodiment of electronic computing device 102 shown in FIG. 1. As described earlier, electronic device 102 may be a laptop, desktop, or tablet computer or even a smartphone but may also be embodied in any one of a wide variety of wired and/or wireless computing devices. As shown in FIG. 4, the electronic device 102 may include a processing device (processor) 402, input/output interfaces 404, a display 406, a network interface 410, a memory 412, and operating system 414, and a mass storage 416, with each communicating across a local data bus 420. Additionally, mobile device 402 incorporates a system for assessing and managing workforce performance 120, which is depicted as including business information 432, worker information 434 and worker engagement data 436, although the location of information 432, 434 and 436 could vary.

The processing device 402 may include any custom made or commercially available processor, a central processing unit (CPU) or an auxiliary processor among several processors associated with the electronic device 102, a semiconductor based microprocessor (in the form of a microchip), a macroprocessor, one or more application specific integrated circuits (ASICs), a plurality of suitably configured digital logic gates, and other electrical configurations comprising discrete elements both individually and in various combinations to coordinate the overall operation of the system.

The memory 412 can include any one of a combination of volatile memory elements (e.g., random-access memory (RAM, such as DRAM, and SRAM, etc.)) and nonvolatile memory elements. The memory typically comprises native operating system 414, one or more native applications, emulation systems, or emulated applications for any of a variety of operating systems and/or emulated hardware platforms, emulated operating systems, etc. For example, the applications may include application specific software which may comprise some or all the components of the mobile device 102. In accordance with such embodiments, the components are stored in memory and executed by the processing device. Note that although depicted separately in FIG. 4, the system and method monitoring and managing productivity 100 may be resident in memory such as memory 412.

Some electronic devices may additionally include a touchscreen interface 408 configured to detect contact within the display area of the display 406. The touchscreen interface 408 may provide such functionality as on-screen buttons, menus, keyboards, etc. that allow users to navigate any of a variety of user interfaces by touch. For some embodiments, the electronic device 102 may even comprise GPS 418 or other means to determine the location of the mobile device 102. It is contemplated that this may be particularly desirable in the event that contractors or other employees are required to travel to perform any of their duties or even in the event that they might be required to contractors or other employees perform any of their job duties in a particularly designated location, though it is not required to practice the invention.

One of ordinary skill in the art will appreciate that the memory 414 can, and typically will, comprise other components which have been omitted for purposes of brevity. Note that in the context of this disclosure, a non-transitory computer-readable medium stores one or more programs for use by or in connection with an instruction execution system, apparatus, or device. With further reference to FIG. 4, network interface device 410 comprises various components used to transmit and/or receive data over a networked environment such as depicted in FIG. 1. When such components are embodied as an application, the one or more components may be stored on a non-transitory computer-readable medium and executed by the processing device.

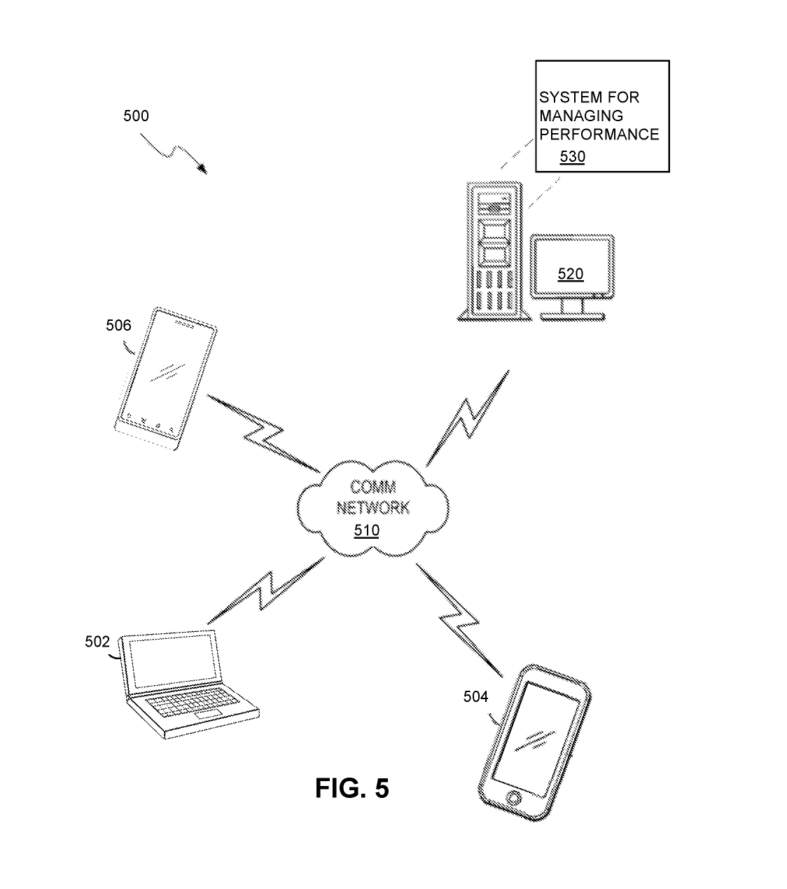

FIG. 5 is illustrative of an alternative networked environment in which another exemplary embodiment of a system for assessing and managing performance in, for example, a remote workforce is implemented. As shown in FIG. 5, system 500 comprises a plurality of electronic computing devices such a laptop computer 502, a smart phone 504 and a tablet computer 506. By way of example, and not limitation, the electronic computing devices 502, 504, 506 are shown communicatively coupled via a communication network 510. Notably, the communications network can use one or more of various communications types such as, for example and without limitation, cellular and Wi-Fi communications.

Users of electronic computing devices 502, 504, and 506 may use their devices to become authenticated members of a sales or other business network that enables them to interact with their supervisors, clients, and even each other using their electronic devices 502, 504, and 506 and exchange information pertinent to their employer's or business's mission. In this exemplary embodiment, the network is facilitated by a website that is hosted by a network server 520. As such, server 520 facilitates interaction among a limited group of members, as may be established by the members themselves. For the purpose of the example presented in FIG. 5, the limited group of members includes the users of electronic computing devices 502, 504 and 506.

Additionally, server 520 implements the system for assessing and managing performance 530 in a remote workforce and facilitates aggregating and comparing data quantifying each network member's work productivity against that of other members in the network, as well as against predetermined threshold values. Specifically, the server 520 implements the steps outlined in FIG. 2. Accordingly, a member, such as an authorized worker or manager, of the network can access the server 520 using their electronic computing devices 502, 504 and 506 to both perform duties as well as obtain information regarding other network members.

In order to facilitate the aforementioned functionality, various aspects may be performed by one or more of the electronic computing devices 502, 504, 506. In one embodiment, mobile device is operative to perform, at least in part, the method depicted in the flowchart of FIG. 2 as described above. Similarly, with respect to operation of system for assessing and managing performance 530 in a remote workforce, system 530 is operative to perform, at least in part, the method depicted in the flowchart of FIG. 2, discussed above.

If embodied in software, it should be noted that each block depicted in the accompanying flowcharts represents a module, segment, or portion of code that comprises program instructions stored on a non-transitory computer readable medium to implement the specified logical function(s). In this regard, the program instructions may be embodied in the form of source code that comprises statements written in a programming language or machine code that comprises numerical instructions recognizable by a suitable execution system such as the mobile device 102, 104, 106, 502, 504, 506. The machine code may be converted from the source code, etc. If embodied in hardware, each block may represent a circuit or a number of interconnected circuits to implement the specified logical function(s). Additionally, although the flowcharts show specific orders of execution, it is to be understood that the orders of execution may differ.

With reference to FIGS. 6 and 7, two exemplary embodiments of user interfaces configured to practice the invention are presented. Of course, one skilled in the art will recognize that the foregoing are offered by way of clarifying example only and not limitation. Indeed, the quality, quantity, and appearance of data presented via such user interface may vary according to, for example, a particular business's needs.

With reference first to FIG. 6, a user interface may be configured to present performance data, which may be used to inform management decisions, associated with a plurality of workers' individual engagement with resources available via some embodiments of private office network in comparison to each other workers' performance data. Such a user interface may be accessible to one or more managers 600, though in some embodiments, it is contemplated that the workers may access such interface as well. For clarity and ease of understanding, a listing of a plurality of remote workers may be sorted in terms of above average performance 602, baseline performance 604—which may be based on predetermined thresholds selected by business owners and others for instance—and even below average performance 606. Arrows 608 or other visual markers, such as numerical percentages, or scores, among others, may be provided to visually summarize each worker's relative productivity and/or performance over some period of time 610. In addition, selected workers' performance may be visually represented in a graph 612. This may aid relevant parties in awarding merit-based bonuses, awards, raises, and promotions, and may further aid relevant parties in developing performance reviews, and even performance improvement plans. In some instances, it may even aid relevant parties in demonstrating cause for terminating certain workers.

An interface configured to display graphical representation of an individual worker's performance over any desirable period of time, as well as data related to his or her particular engagement with resources available via the private office network, may also be provided as shown, for example, in FIG. 7. It may be seen in one embodiment, that such worker's engagement with a variety of electronically implemented office resources 620 may be displayed for review. For instance, time spent on docs, calls, conference calls as well as record updates, emails sent and received, and chat time, may be drawn from the worker's actual engagement with any related applications and software available in the private office network, or even virtual office environment. Whether or not that worker's engagement with such resources is deemed average, below average, or above average—as compared to his own historical performance, performance of his peers, and even predetermined performance thresholds—may also be illustrated 622. The worker's productivity may be listed as a percentile rating 624, or score, as compared to all other workers, though it is contemplated that other percentages may be presented for consideration. In some embodiments, the individual's engagement with various resources available by way of the private office network may be presented as a graphic chart 626.

In this way, and others contemplated but not drawn, each worker's engagement with resources available in an office network may be considered as against his own performance, his coworkers' performance, and baseline performance requirements.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

### CONCLUSIONS, RAMIFICATIONS, AND SCOPE

While certain embodiments of the invention have been illustrated and described, various modifications are contemplated and can be made without departing from the spirit and scope of the invention. Accordingly, it is intended that the invention not be limited, except as by the appended claim(s).

The teachings disclosed herein may be applied to other systems, and may not necessarily be limited to any described herein. The elements and acts of the various embodiments described above can be combined to provide further embodiments. All of the above patents and applications and other references, including any that may be listed in accompanying filing papers, are incorporated herein by reference. Aspects of the invention can be modified, if necessary, to employ the systems, functions and concepts of the various references described above to provide yet further embodiments of the invention.

Particular terminology used when describing certain features or aspects of the invention should not be taken to imply that the terminology is being refined herein to be restricted to any specific characteristics, features, or aspects of the system, method, and apparatus for assessing and managing workforce performance with which that terminology is associated. In general, the terms used in the following claims should not be constructed to limit the system, method, and apparatus for assessing and managing workforce performance to the specific embodiments disclosed in the specification unless the above description section explicitly define such terms. Accordingly, the actual scope encompasses not only the disclosed embodiments, but also all equivalent ways of practicing or implementing the disclosed system, method and apparatus. The above description of embodiments of the system, method, and apparatus for assessing and managing workforce performance is not intended to be exhaustive or limited to the precise form disclosed above or to a particular field of usage.

While specific embodiments of, and examples for, the method, system, and apparatus are described above for illustrative purposes, various equivalent modifications are possible for which those skilled in the relevant art will recognize.

While certain aspects of the method and system disclosed are presented below in particular claim forms, various aspects of the method, system, and apparatus are contemplated in any number of claim forms. Thus, the inventor reserves the right to add additional claims after filing the application to pursue such additional claim forms for other aspects of the system, method, and apparatus for assessing and managing workforce performance.

What is claimed is:

1. A system for assessing performance of a plurality of workers executing tasks in a digitally implemented office network, comprising:
at least one electronic computing device corresponding to a managing member of the office network, said electronic computing device operative to:
authorize access to the office network;
receive identifying information corresponding to each of a plurality of workers authorized to access the office network;
receive information associated with at least a second computing device operative to engage with resources available in the office network, the at least second electronic computing device corresponding to one each of the plurality of identified workers authorized to access the office network, the received information corresponding to each worker's engagement with one or more electronic resources available in the office environment network; and
display statistical information corresponding to the received information.

2. The system of claim 1, wherein the digitally implemented office network defines a virtual office environment comprising a cloud-based office suite including any of at least email, telephone, intranetwork communication, word processing, and calendaring functionality accessible to each identified member of the network.

3. A method for managing performance of a plurality of workers in a remote workforce, comprising:
receiving, at a first electronic device corresponding to a manager, worker information corresponding to a plurality of workers authorized to perform any job-related duties in a digitally implemented office network;
receiving, at the at least one electronic computing device, information associated with at least a second computing device operative to engage with resources available in the office network, the at least second electronic computing device corresponding to one each of the plurality of identified workers authorized to access the office network, the received information corresponding to each worker's engagement with one or more electronic resources available in the office network; and
displaying, at the at least one electronic computing device, statistical information corresponding to the received information.

4. A non-transitory, tangible computer readable medium having stored thereon computer-executable instructions, which, when executed by a computer processor, enable performance of the method comprising:
authorizing, at an at least one electronic computing device corresponding to a managing member of a private, digitally implemented office network, access to the office network;
receiving, at the at least one electronic computing device, identifying information corresponding to each of a plurality of workers authorized to access the office network;
receiving, at the at least one electronic computing device, information associated with at least a second computing device operative to engage with resources available in the office network, the at least second electronic computing device corresponding to one each of the plurality of identified workers authorized to access the office network, the received information corresponding to each worker's engagement with one or more electronic resources available in the office network; and
displaying, at the at least one electronic computing device, statistical information corresponding to the received information.
